(19) United States
(12) Patent Application Publication
(10) Pub. No.: US 2010/0185796 A1
(43) Pub. Date: Jul. 22, 2010

(54) INTERFACE COMPONENT AND METHOD FOR THE OPERATION THEREOF

(75) Inventors: Jens Schneider, Berlin (DE); Stephan Mannshardt, Teufelshof (DE); Thomas Stemmer, Stahnsdorf (DE)

Correspondence Address: FOLEY AND LARDNER LLP;SUITE 500, 3000 K STREET NW, WASHINGTON, DC, 20007, US

(73) Assignee: LUCEO TECHNOLOGIES GMBH

(21) Appl. No.: 12/450,075

(22) PCT Filed: Mar. 4, 2008
(86) PCT No.: PCT/EP2008/001696

§ 371 Date: Apr. 1, 2010

(30) Foreign Application Priority Data
Mar. 13, 2007 (EP) 07005144.6

(51) Int. Cl. G06F 13/38

(52) U.S. Cl. 710/63; 710/65

(57) ABSTRACT

The invention concerns an interface unit (50,80) with an electrical interface (40, 110) for connection to an electrical USB cable, an optical interface to connect to at least one optical waveguide for sending and receiving of optical signals, and a conversion unit that is capable of converting the signals D+ and D− at the electrical interface to optical signals for output at the optical interface, and that is capable of converting the optical signals from the optical interface to electrical signals and output these signals as D+ and D− at the electrical interface

According to the invention it is defined that the conversion unit has an analyzing unit (210) for separation of the useful signals (NS) and the control signals (SS) that are contained in the D+ and D− signals, and that the analyzing unit is subsequently connected to a recovery unit (220, 400) that generates at least two electrical driver signals for subsequent sending units out of the useful signals (NS) and the control signals (SS), and that the subsequent sending units generate at least two optical signals with at least two different wavelength channels out of the at least two incoming electrical signals and output them at the optical interface.

The invention is related to an interface unit with the characteristics according to the preamble of claim 1.

The so called Universal Serial Bus—USB—is an electrical interface for Personal Computers (PC) for connection of peripherals like keyboard, mouse, camera, printer, etc. The specification is published at www.usb.org. USB 2.0 is limited to 5 m cable length. That is a significant limitation for several applications.

Electrical Bus systems like USB that use a multi-level logic with more than two logical states are not directly adaptable to optical data transmission. Besides pure data transmission USB also has to transfer additional state information about the peripheral devices i.e.
Peripheral is connected and active
Selected transmission speed
Send or receive
Send or pause

USB data is transmitted via differential signal lines D+ and D−. Logic “0” stands for D+=0 and D−=1, logic 1 equals D+=1 and D−=0. Furthermore there are the states D+=0 and D−=0 and D+=1 and D−=1. These signal conditions are not static; they occur bitwise i.e. for two bits as an End of Packet (EOP) identifier of Full speed connections, or as Idle for High-Speed.

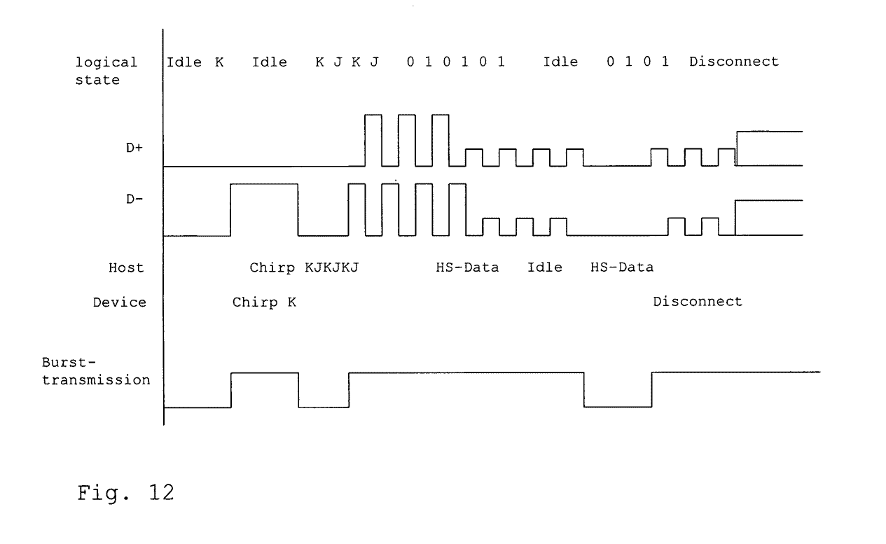

The USB connection establishment goes through several stages which are encoded by time and amplitude. The time information will be maintained in the optical transmission and can therefore stay untouched. In FIG. 12 are examples of logical and operational states of a high-speed connection from connection establishment up to the termination.

In the following table all these logical states are described that are important for complete signaling of all USB operational states for USB 1.x and 2.0:

| | |
|---|---|
| 0 | Data logical 0 |
| 1 | Data logical 1 |
| J | Chirp J |
| K | Chirp K |
| Disconnect | Peripheral disconnected |
| Idle | Connected but no data transfer |

The electrical characteristics are precisely specified in the USB 2.0 standard.

A USB Interface unit as defined above is known from U.S. Pat. No. 6,950,610. That unit contains an electrical interface for connection to a USB cable and an optical interface for connection to two optical waveguides. A conversion unit translates the data D+ and D− from the electrical interface to optical signals and translates the optical input data to the electrical signal D+ and D− output. The mentioned unit encodes the D+ and D− into a ternary code consisting of a binary signal and an analog coded signal. The result is to be transferred optically. The signal amplitude of the optical signal in the mentioned unit plays a significant role. So usage for USB 1.0 is possible whereas direct usage for USB 2.0 is not possible because USB 2.0, besides other functions, uses a change in the amplitude as an indicator of the data rate. The amplitude is also used to signal IDLE packets. It would be possible to generate more amplitude levels for the additional operating modes, however those levels would change due to attenuation of the optical fiber and connector losses.

The task of the invention is to define an interface unit that transfers data reliably also at higher data rates, and is inherently compatible to the USB 2.0 standard.

According to the invention this task will be fulfilled by the attributes in claim 1. Usable Variants are shown in the claims and subclaims.

Therefore it is defined by the invention that the conversion unit has an analyzing unit that separates the control signals (USB status signals) contained within the D+ and D− signals, from the useful signal (USB useful signal). The analyzing unit is followed by a signal recovery unit that generates at least two driving signals for driving following transmission units. The following transmission units generate at least two optical signals with at least two different wavelengths driven by at least two electrical signals and output these signals at the optical interface.

A significant advantage of the interface unit according to the invention is that due to the intended preanalysis of the D+ and D− signals according to the invention, the intended separation of the D+ and D− signals in the USB control signals and USB-useful signal according to the invention, and the intended transmission of data through at least two optical wavelength-channels according to the invention, there are additional degrees of freedom that can be used for a simple way to transfer data in compliance with the USB 2.0 standard. For example this allows for sending the information at the USB2.0 transmission speed whilst maintaining compatibility to earlier versions of the standard. Also since USB 2.0 is block-orientated, handling of empty blocks similar to EOP of the USB1.0 is possible. The differentiation to EOP can for example be done in combination with the speed indication. Furthermore the USB permitted function of anytime plugging and unplugging of the peripherals can be handled by having ( ) dedicated signaling for connected (active) and not connected (inactive) peripheral devices.

The conversion unit primarily transfers the useful signal on a separate dedicated wavelength channel. In contrast to the low speed or almost static control signals, the high speed or very dynamic signals of the useful signal are primarily generated with a laser. The low speed signals are generated mainly with LEDs.

An additional benefit results from the recovery unit logically combining at least two of the control signals while generating an electrical driver signal, so that a consecutive transmission unit generates an optical signal at a special wavelength based on the driver signal and output at the optical interface. Such a combination for USB 2.0 is therefore beneficial because some of the USB control signals are redundant in content and can therefore be combined, transferred, or even not sent.

Also for example, the interface unit can be of the kind that allows the recovery unit to logically combine at least one of the control signals with the useful signal while generating an electrical driver signal, so that a consecutive transmission unit generates a dedicated wavelength channel based on this driver signal and outputs it at the optical interface. This kind of combination with the useful signals is recommended for example for transfer of very low speed control signals that do not disturb or slow down the transfer of the useful signals.

The wavelength channels can have different frequency rates. Alternatively there could be an overlap of the wavelength of the different channels i.e. when they have different spectral channel widths.

The interface unit sends exclusively binary coded signals in order to dispense with a multilevel analog transmission as described in the aforementioned interface unit description. A multilevel analog transmission has the disadvantage that the absolute signal level has to be known by the receiver for a proper signal analysis. This level can change due to attenuation caused by for example small bending radiuses or unstable quality of the optical connection. Therefore a multi-level transmission can be faulty.

Furthermore it is beneficial that the conversion unit contains a recovery unit that is able to simultaneously receive at least two optical wavelength channels at the optical input, and generate a useful signal out of these received signals, and that the recovery unit is connected to an analyzing unit that generates the D+ and D− signals for the electrical output out of the control signals and the useful signals.

The invention also includes a method for transmission of a USB compatible signal where D+ and D− are converted into optical signals and transmitted through at least one optical waveguide i.e. glass fiber.

The invention meets the requirement that a reliable data transmission is also achieved at high data rates and the principle procedure allows for compatibility with USB 2.0.

According to the invention the control signals and useful signals derived from the electrical D+ and D+ signals are transferred through at least two optical wavelength channels over at least one optical transmission media.

Regarding the advantages of the method and beneficial forms of the method, we refer to the aforementioned description concerning the interface unit according to the invention.

The invention will be explained subsequently with exemplary embodiments

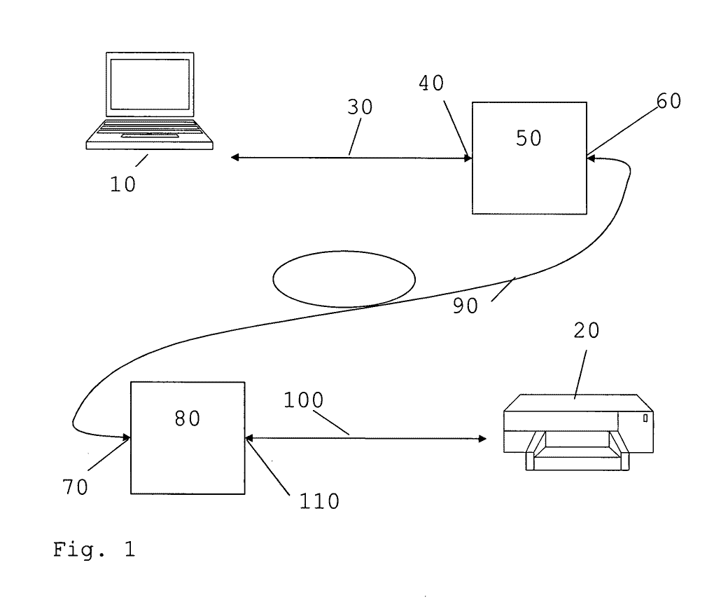

FIG. 1 a setup of two electrical devices which are connected via a USB connection, where two USB interface units make an electro-optical conversion on the transmission channel;

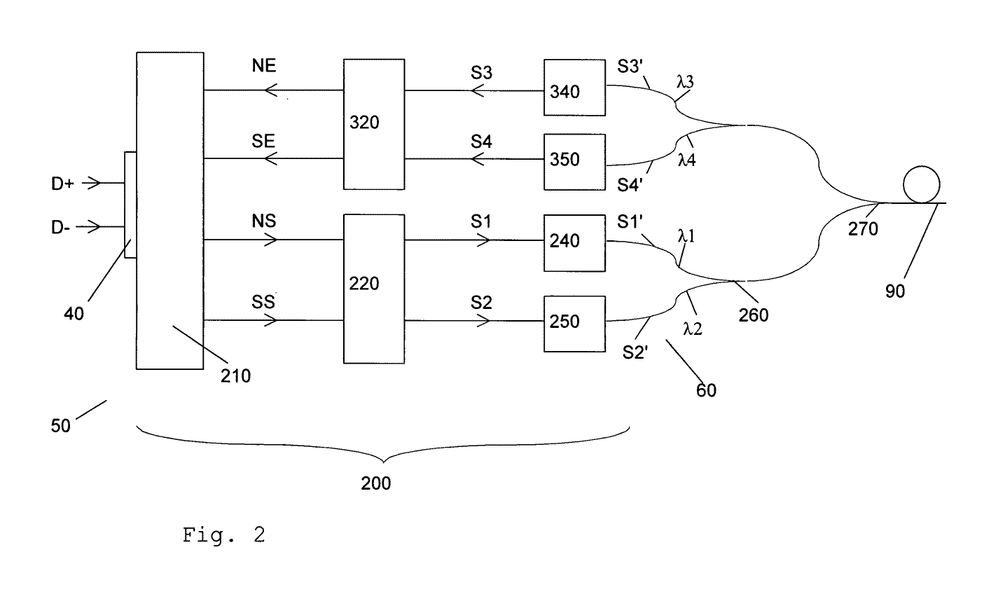

FIG. 2 a first exemplary embodiment for a USB interface unit according to the invention where the USB useful signals and the USB status signals go through two different wavelength channels;

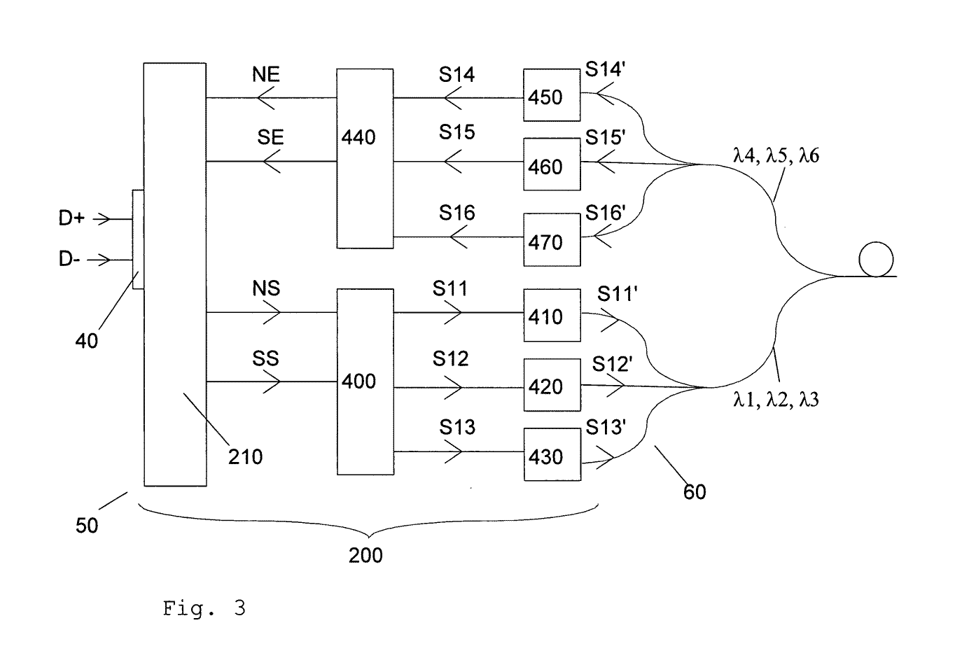

FIG. 3 a second exemplary embodiment for a USB interface unit according to the invention where the USB useful signal goes through one wavelength channel and the USB status signals are combined and go through two other wavelength channels;

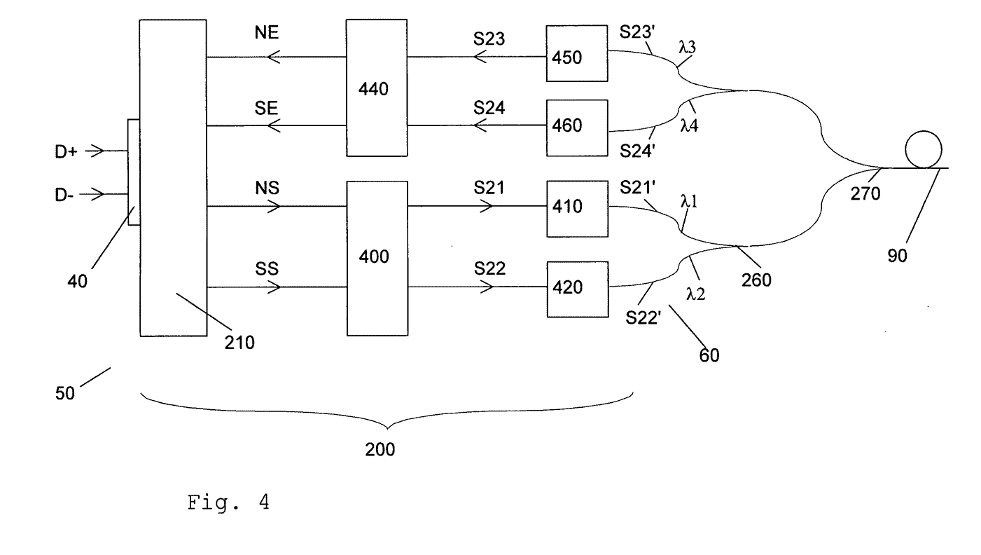

FIG. 4 a third exemplary embodiment for a USB interface unit according to the invention where the USB useful signal and the USB status signals are combined and go through two wavelength channels;

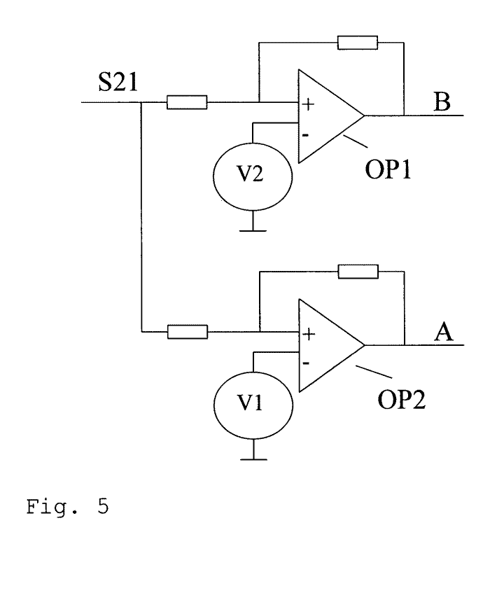

FIG. 5 a schematic for a recovery unit of the USB interface unit according to FIG. 4;

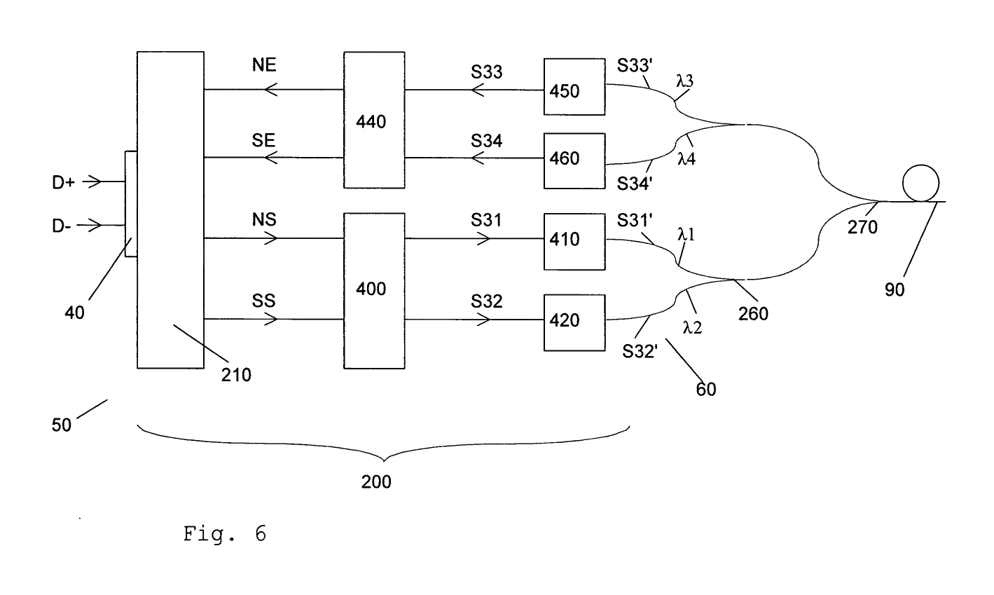

FIG. 6 a fourth exemplary embodiment for a USB interface unit according to the invention where the USB useful signal and the USB status signals are combined and digitally encoded signals are being transferred;

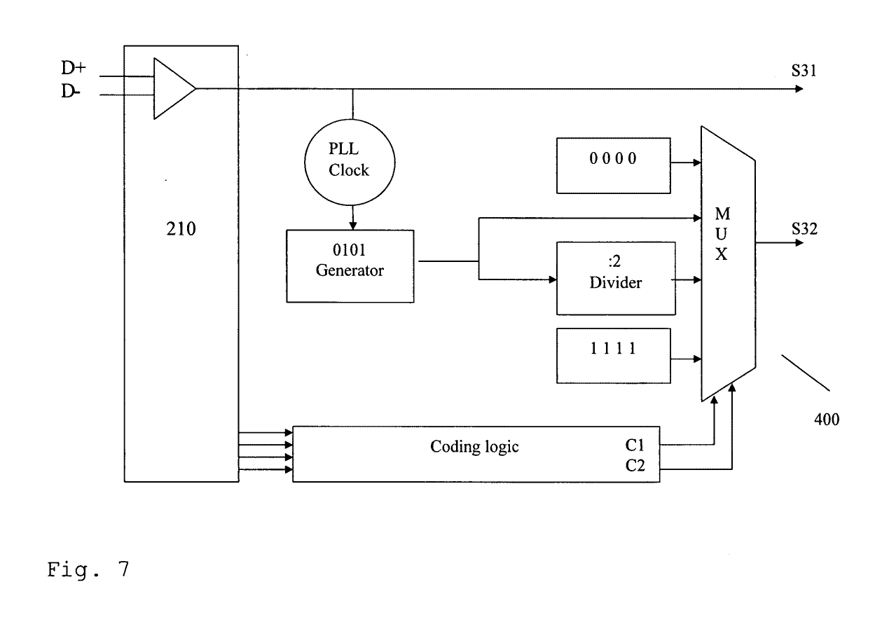

FIG. 7 a schematic for a recovery unit of the USB interface unit according to FIG. 6;

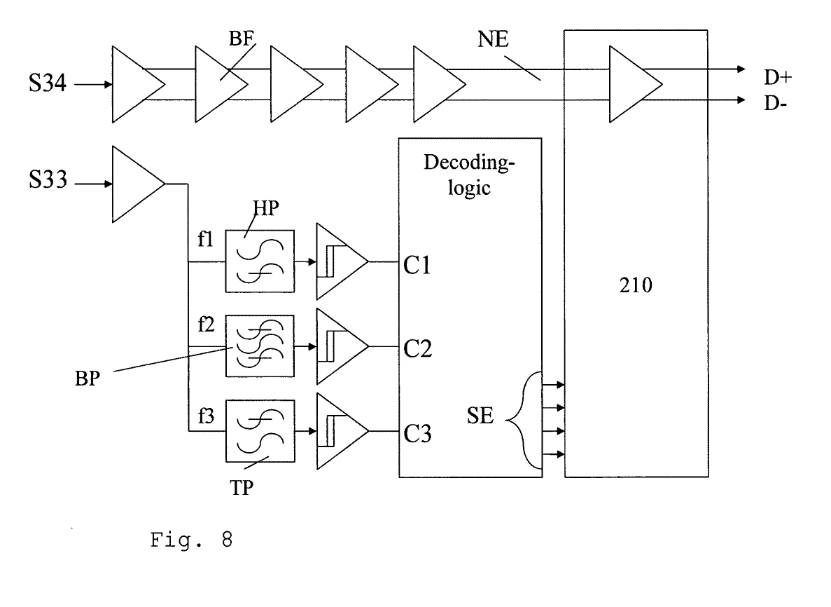

FIG. 8 another schematic for a recovery unit of the USB interface unit according to FIG. 6;

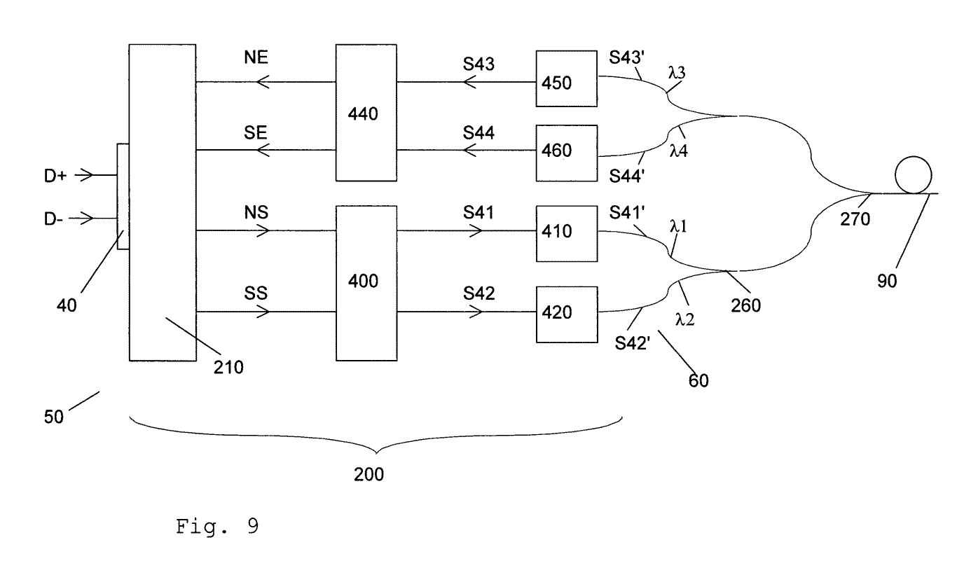

FIG. 9 a fifth exemplary embodiment for a USB interface unit according to the invention where the USB useful signal and the USB status signals are combined and analog-digital encoded and transferred through two wavelength channels;

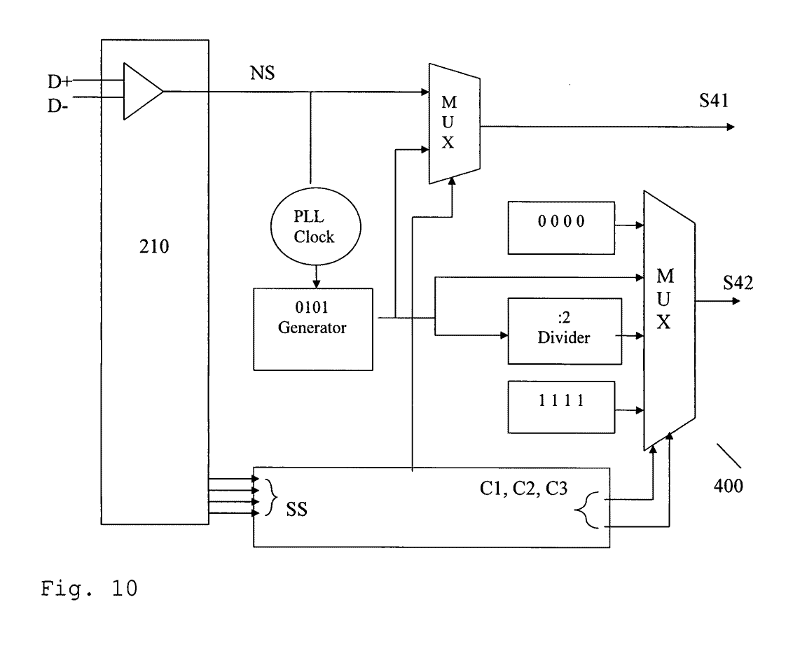

FIG. 10 a schematic for a recovery unit of the USB interface unit according to FIG. 9;

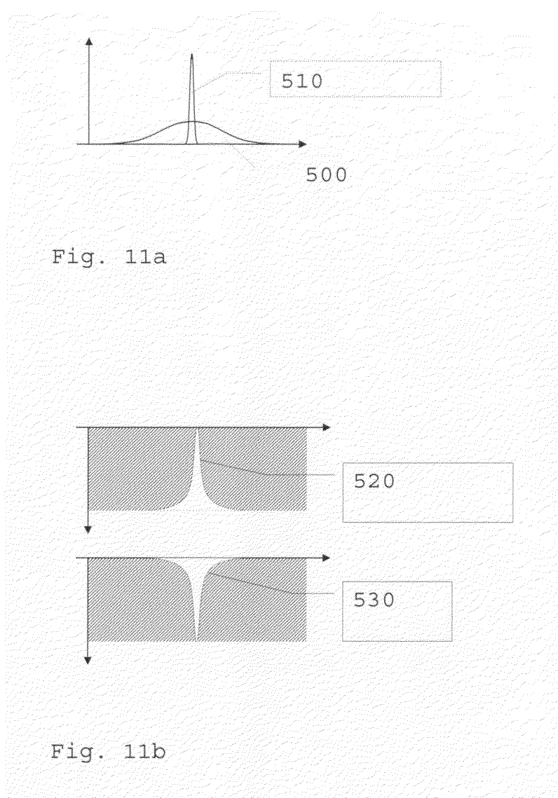

FIGS. 11a, 11b optical wavelength channels and filters for filtering the optical signals;

FIG. 12 exemplarily examples of logical and operational states for a high speed connection according to USB standard from start of connection up to termination of connection; and

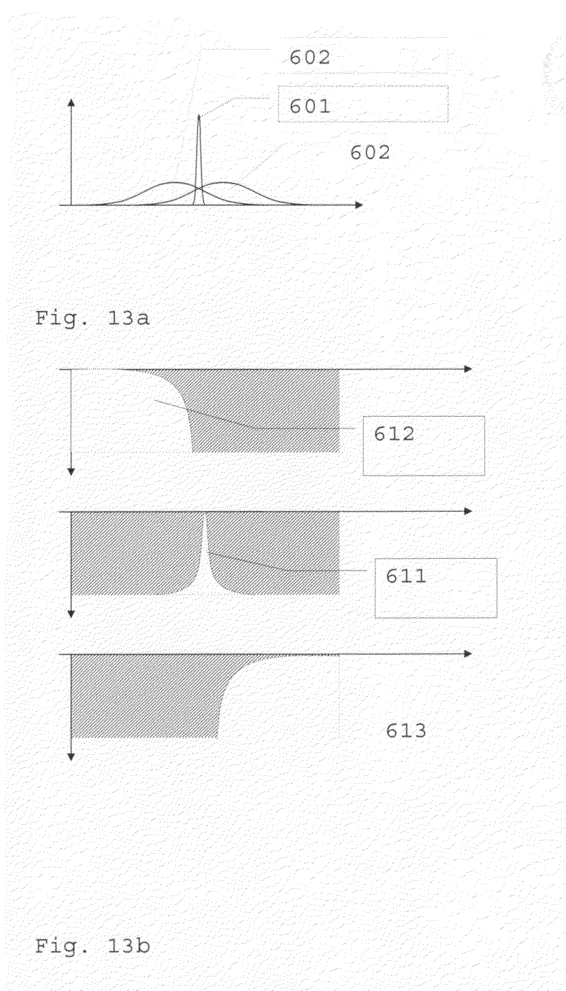

FIGS. 13a, 13b further optical wavelength channels and filter for filtering of the optical signals;

In FIGS. 1 to 13b the same reference symbols are used for a better overview of comparable or identical components.

In FIG. 1 is shown a setup of two electrical units 10 and 20 that are communicating with each other. Unit 10 could be a personal computer and unit 20 could be a printer.

Unit 10 is connected to the electrical interface 40 of the first interface unit 50 via a USB cable 30 which is compliant with USB standard 2.0. The first interface unit 50 is connected to an optical interface 70 of a second interface unit 80 via the optical interface 60 and the optical connection 90. The optical connection 90 could be implemented as a single waveguide or a multiple waveguide. The device 20 is connected via a second USB cable 100 to an electrical interface 110 of the second interface unit 80.

In FIG. 2 an exemplary embodiment of the first interface unit 50 is described. The second interface unit 80 can be of identical or at least similar structure.

At the electrical interface 40 in FIG. 2, the D+ and D− of the device 10 are present. The electrical interface 40 is connected to a conversion unit 200 with a analyzing unit 210 that analyzes the D+ and D− signals and creates an optical signal “HS_Differential_Receiver_Output”—subsequently called USB useful signal NS—and optical control signals (USB status signals) SS at the output. The analyzing unit 210 can be implemented with or containing i.e. the USB2.0 ICs USB1T1102 from Fairchild and the IC CY7C68000 from Cypress.

The signals SS can for example be single or all of the subsequent shown signals according to USB2.0 standard:
“Rpu_Enable”
“HS_Current_Source_Enable”
“HS_Drive_Enable”
“HS_Data_Driver_Input”
“LS/FS_Data_Driver_Input”
“Assert_Single_Ended_Zero”
“FS_Edge_Mode_Sel”
“LS/FS_Driver_Output_Enable”
“Squelch”
“LS/FS_Differential_Receiver_Output”
“HS_Disconnect”
“SE_Data+_Receiver_Output”
“SE_Data−_Receiver_Output”

The conversion unit 200 contains a recovery unit 220 which is driven by the analyzing unit 210 and at the output is assigned to two optical transmission units 240 and 250. The optical transmission units 240 and 250 can for example contain laser diodes or light emitting diodes (LED). For a better overview the LEDs are not shown in FIG. 2.

The recovery unit 220 converts the optical useful signal NS of the analyzing unit 210 to an electrical driver signal S1 that is used by the optical transmission unit 240 to generate the optical signal S1′ on the wavelength channel λ1 or with the wavelength λ1, respectively.

In a similar way as described above the recovery unit 220 converts a single or all of the control signals SS of the analyzing unit 210 to an electrical driving signal S2 that is used by the optical transmission unit 250 to generate the optical signal S2′ with the wavelength λ2. The conversion of the control signals SS of the analyzing unit 210 to the electrical driving signal S2 can for example be implemented with a digital encoding and/or with a time multiplex method.

The two optical signals S1′ and S2′ are fed into the optical connection 90 through Y-splitter 260 and 270 according to FIG. 1. The diagram in FIG. 2 assumes that the optical connection 90 is made with a single waveguide.

The conversion unit 200 further contains a recovery unit 320 which at the input is connected to two optical receiving units 340 and 350. The optical receiving units 340 and 350 can for example contain receiver diodes; those diodes are not shown in FIG. 2 for a better overview.

The optical receiving unit 340 receives the optical signal S3′ with the wavelength λ3 and generates a congruent electrical signal S3 that is used by the recovery unit 320 to generate an electrical useful signal NE at the interface 40.

In a similar way as described above the optical receiving unit 350 receives an optical signal S4′ with the wavelength λ4 and generates a congruent electrical signal S4 that is used by the recovery unit 320 to generate electrical control signals SE.

The analyzing unit 210 which is subsequently connected to the recovery unit 320 generates with the optically received and electrically to be sent control signals SE and with the optically received and electrically to be sent useful signal NE at the output the signals D+ and D− that are fed into the USB cable through the electrical interface 40 of the first interface unit 50 according to FIG. 50.

As a conclusion in the exemplary embodiment according to FIG. 2, the four optical wavelengths λ1-λ4 are used for the bidirectional transmission of a USB2.0 signal, i.e.:
the wavelength λ1 for the optical transmission unit for sending the optical useful signals NS (HS_Differential_Receiver_Output”),
the wavelength λ2 for the optical sending unit for sending the optical control signals SS,
the wavelength λ3 for the optical receiving unit and for receiving the optical useful signal NE (“HS_Data_Driver_Input”) and
the wavelength λ4 for the optical receiving unit and for receiving the control signals SE.

In conjunction with FIG. 3 it is now another exemplary embodiment for the first interface unit 50 and therefore also for the second interface unit 80. In the exemplary embodiment according to FIG. 3, three wavelengths for each of the directions sending and receiving are used.

In FIG. 3 is shown the electrical interface 40 into which the electrical D+ and D− signals of the device 10 are fed. The electrical interface 40 is connected to a conversion unit 200 containing an analyzing unit 210 that analyzes the D+ and D− signals and at the output generates the signal “HS_Differential_Receiver_Output”—subsequently called useful signal NS—and the control signals SS.

The conversion unit 200 contains also at the sending side a recovery unit 400 that is connected to the analyzing unit 210 and that at the output is assigned to three optical sending units 410, 420 and 430. The optical sending units can for example contain laser diodes or light emitting diodes.

The recovery unit 400 is used for generation of the three driving signals S11, S12 and S13 out of the useful signal NS and the control signals SS from the analyzing unit 210, for example ( ):
S11=HS_Differential_Receiver_Output
S12=((SE_Data+_Receiver_Output)OR (SE_Data−_Receiver_Output)) AND NOT(Squelch)
S13=NOT(HS_Differential_Receiver) AND NOT(HS_Disconnect)

The following table shows the coding scheme in a different structure with the assigned USB signal states:

| Coding table for sending from device | | | |
|---|---|---|---|
| 10 to device 20 (signal | | | |
| states according to USB2.0 standard) | S11 | S12 | S13 |
| Disconnect | 0 | 0 | 0 |
| Idle | 0 | 0 | 1 |
| Idle | 1 | 0 | 1 |
| K | 0 | 1 | 1 |
| J | 1 | 1 | 1 |
| 0 | 0 | 1 | 0 |
| 1 | 1 | 1 | 0 |

The three optical sending units 410, 420, and 430 create the optical signals S11′, S12′ and S13′ with the wavelengths λ1, λ2 and λ3 out of the three driver signals S11, S12 and S13 and couple these into the optical connection 90. In case of an interruption of the electrical connection at the interface 40, no light will be sent. This also has the advantage that the optical connection can be interrupted without the need to disconnect the interface units 50 or 80 from the device.

The conversion unit 200 also contains at the receiving side a recovery unit 440 that at the input is assigned to three optical receiving units 450, 460 and 470. The three optical receiving units 450, 460 and 470 are receiving optical signals S14′, S15′ and S16′ with the wavelengths λ4, λ5 and λ6 and at the output generate congruent driver signals S14, S15 and S16. These are used by the recovery unit 440 to generate the optically received and electrically (at the interface 40) to be sent useful signal NE, and the optically received and electrically (from the interface 40) to be sent control signals SE.

Control signals SE can for example be generated such as:

### Rpu_Enable=S12 AND S13

### HS_Current_Source_Enable=S12 AND NOT(S13)AND S11

### HS_Drive_Enable=S12 AND NOT(S13)

### HS_Data_Driver_Input=S11

### LS/FS_Data_Driver_Input=S11

### Assert_Single_Ended_Zero=NOT(S12) AND S13

### FS_Edge_Mode_Sel=S12 AND S13

### LS/FS_Driver_Output_Enable=S12 AND S13

The following table shows the decoding scheme in a different structure with the assigned USB signaling states:

| | | | Decoding table for receiving optical data |
|---|---|---|---|
| | | | from device 20 and for the transmission of |
| | | | electrical data to device 10 (signal states |
| S14 | S15 | S16 | according to USB2.0-Standard) |
| 0 | 0 | 0 | Disconnect |
| 0 | 0 | 1 | Idle |
| 1 | 0 | 1 | Idle |
| 0 | 1 | 1 | K |
| 1 | 1 | 1 | J |
| 0 | 1 | 0 | 0 |
| 1 | 1 | 0 | 1 |

The optical signals with the wavelengths λ1, λ2, λ3, λ4, λ5, λ6 can be generated by different types of sending elements. For a data rate of 480 Mb/s laser diodes are recommended for the wavelengths λ1 and λ4 because through these wavelengths the useful data NS as the USB signal “HS_Differential_Receiver_Output” is transmitted.

For the wavelengths λ2, λ3, λ5 and λ6 low speed LEDs could also be used because the signaling of the states with the control signals S12, S13, S15 and S16 is encoded in a manner that allows for a lower bit rate like 120 MBit/s. LEDs are more cost effective and simplify the use of optical filters at the receiver.

In conjunction with FIG. 4 a third exemplary embodiment for the interface units 50 and 80 according to FIG. 1 is described. In the exemplary embodiment according to FIG. 4 two wavelengths for both the sending and the receiving direction are used.

In FIG. 4 the electrical signals D+ and D− of device 10 are connected to the electrical interface 40. It is connected to a conversion unit 200 with an analyzing unit 210 which analyzes the signals D+ and D− and generates the useful signal NS (“HS_Differential_Receiver_Output”) and the control signals SS.

The conversion unit 200 also contains at the transmission side a recovery unit 400 which gets the data from the analyzing unit 210 and which on the sending side is assigned to two optical transmission units 410 and 420. Those optical sending units could for example contain laser diodes or light emitting diodes.

The recovery unit 400 has to generate two electrical driver signals S21 and S22 based on the useable signal NS and the control signals SS from the analyzing unit 210. Examples are:

### S21=HS_Differential_Receiver_Output OR NOT((SE_Data+_Receiver_Output)OR(SE_Data−_Receiver_Output))

### S22=NOT(Squelch) AND LS/FS_Differential_Receiver_Output)+NOT(HS_Disconnect)

The logical “+” stands for the addition of the signal amplitudes.

The following table shows the encoding scheme in a different structure and regarding the USB signal states:

| Encoding table for sending from device 10 | | |
|---|---|---|
| to device 20 (signal states according to | | |
| USB2.0 standard) | S22 | S21 |
| Disconnect | 0 | 0 |
| Idle | 0 | 1 |
| K | 2 | 0 |
| J | 2 | 1 |
| 0 | 1 | 0 |
| 1 | 1 | 1 |

The two optical sending units 410 and 420 generate the optical signals S21′ and S22′ with the wavelengths λ1 and λ2 based on the incoming signals S21 and S22 and couple these into the optical connection 90.

The conversion unit 200 contains additionally a recovery unit 440 at the receiving side which is driven by two optical receiving units 450 and 460. The two receiving units 450 and 460 receive the optical signals S23′ and S24′ of the device 20 with the wavelengths λ3 and λ4 and generate at the output the signals S23 and S24. These are used by the recovery unit 440 to generate an optically received and electrically (at the interface 40) to be sent useful signal NE and optically received and electrically (at the interface 40) to be sent control signals SE.

The control signals SE will for example be formed according to:

### Rpu_Enable=A AND B

### HS_Current_Source_Enable=S24 AND A AND NOT(B)

### HS_Drive_Enable=A AND NOT(B)

### HS_Data_Driver_Input=S24

### LS/FS_Data_Driver_Input=S24

### Assert_Single_Ended_Zero=NOT(A) AND NOT(B)

### FS_Edge_Mode_Sel=A AND B

### LS/FS_Driver_Output_Enable=A AND B

Whereas the values for A and B are defined in the following table which also contains the decoding scheme in a different structure according to the USB signal states:

| | | | | Decoding table for optical receiving |
|---|---|---|---|---|
| | | | | from device 20 and electrical sending |
| | | | | to device 10 (signal states according |
| S22 | S21 | A | B | to USB2.0 standard) |
| 0 | 0 | 0 | 0 | Disconnect |
| 0 | 1 | 0 | 0 | Idle |
| 2 | 0 | 1 | 1 | K |
| 2 | 1 | 1 | 1 | J |
| 1 | 0 | 1 | 0 | 0 |
| 1 | 1 | 1 | 0 | 1 |

The generation of the binary intermediate states from the ternary code of signal S21 is given as an example in FIG. 5. The operational Amplifiers OP1 and OP2 have different reference voltages V1 and V2. Those allow for reliable switching of the OP AMPs, for example V1=0.5 V and V2=1.5 V, when the maximum amplitude of signal S21 equals 2V.

For the assignment of the logical intermediate states, alternatives are also possible. The described coding scheme is however beneficial because it has the following attributes:
The optical connection may be interrupted because in that case the proper value for HS_Disconnect will be coded if all channels are off, and
S21 can be generated by a simple LED because only slow signals have to be transferred.

In FIG. 6 the fourth exemplary embodiment for the first interface unit 50 and the second interface unit 80 according to FIG. 1 is described. In the exemplary embodiment in FIG. 6 two wavelengths are used both in the send and receive direction.

The electrical interface 40 in FIG. 6 receives electrical data D+ and D− from the device 10.

The electrical interface 40 is connected to a conversion unit 200 with an analyzing unit 210 which analyzes the D+ and D− signals and outputs the signal “HS_Differential_Receiver_Output” as a useful signal NS, and the control signals SS.

The conversion unit 200 also contains on the sending side a recovery unit 400 that takes over the signals from the analyzing unit 210 and which are assigned at the output to two optical sending units 410 and 420. These sending units can for example contain laserd diodes or light emitting diodes. The purpose of the recovery unit 400 is to generate two electrical driver signals S31 and S32 based on the useful signal NS and the control signals SS of the analyzing unit 210.

### S31=HS_Differential_Receiver_Output

The signal S32 is generated with the intermediate values C1 and C2 according to the following equations and table:

C1=NOT(Squelch) OR NOT(HS_Disconnect)

C2=NOT(Squelch) AND HS_Disconnect

| Code-Folge für S32 | C1 | C2 |
|---|---|---|
| 0000 | 0 | 0 |
| 0101 | 0 | 1 |
| 1111 | 1 | 1 |
| 1111 | 1 | 1 |
| 0011 | 1 | 0 |
| 0011 | 1 | 0 |

The following table shows the encoding scheme in a different structure with respect to the USB signal states.

| Encoding table | | | | |
|---|---|---|---|---|
| for sending | | | | |
| from device 10 | | | | |
| to device 20 | | | | |
| (signal states | | | | |
| according to | | | | |
| USB2.0- | | Code pattern for | | |
| Standard) | S31 | S32 | C1 | C2 |
| Disconnect | 0 | 0000 | 0 | 0 |
| Idle | 0 | 0101 | 0 | 1 |
| K | 0 | 1111 | 1 | 1 |
| J | 1 | 1111 | 1 | 1 |
| 0 | 0 | 0011 | 1 | 0 |
| 1 | 1 | 0011 | 1 | 0 |

The two optical sending units 410 and 420 generate the optical signals S31′ and S32′ with the wavelengths λ1 and λ2 based on the electrical driver signals S31 and S32 and couple these into the optical connection 90.

The code pattern of the driver signal S31 can be generated in the recovery unit 400 at the sending side for example with a schematic according to the diagram in FIG. 7.

The conversion unit 200 also contains at the receive side a recovery unit 440 which takes the signal from the optical receiving units 450 and 460. These units 450 and 460 receive optical signals S33′ and S34′ with the wavelengths λ3 and λ4 and generate at the output related electrical driver signals S33 and S34 that are used by the recovery unit 440 to generate an optical received and electrically to be sent (through interface 40) useful signal NE and optically received and electrically (through the interface 40) to be sent control signals SE.

The control signals SE can for example be generated with the intermediate values C1, C2 and C3 as follows:

| | | | | | Decoding table for optical receiving |
|---|---|---|---|---|---|
| | | | | | from device 20 and for electrical |
| | | | | | sending to device 10 (signal states |
| S34 | S33 | C1 | C2 | C3 | according to USB2.0-Standard) |
| 0 | 0000 | 0 | 0 | 1 | Disconnect |
| 0 | 0101 | 1 | 0 | 0 | Idle |
| 0 | 1111 | 0 | 0 | 1 | K |
| 1 | 1111 | 0 | 0 | 1 | J |
| 0 | 0011 | 0 | 1 | 0 | 0 |
| 1 | 0011 | 0 | 1 | 0 | 1 |

The intermediate values C1, C2 and C3 will be used to generate the optical received and electrical to be sent control signals SE:

### Rpu_Enable=C3

### HS_Current_Source_Enable=C1 OR C2

### HS_Drive_Enable=C1 OR C2

### HS_Data_Driver_Input=S34

### LS/FS_Data_Driver_Input=S34

### Assert_Single_Ended_Zero=C1

### FS_Edge_Mode_Sel=C3

### LS/FS_Driver_Output_Enable=C3

The generation of the intermediate values C1, C2 and C3 is given as an example in FIG. 8. The filter frequency f1 of the high pass HP, the transit frequency f2 of the band pass BP and the filter frequency f3 of the low pass TP are selected primarily to be at least similar in relation to the bit rate B of the useful signal NS as follows:

f1≧B/2=240 MHz (for B=480 Mbit/s)

f2≈B/4=120 MHz (for B=480 Mbit/s)

f3≦B/4=120 MHz (for B=480 Mbit/s)

So the bit pattern “0101” is detectable with the high pass HP, the pattern “0011” is detectable with the band pass BP and static patterns (longer than 4 bit) are detectable with the low pass TP. The four buffers BF are for proper delay time of the four bits so that the right states of the USB sending interface are available in time.

Many optical transducers have a problem to transfer so called burst signals. In case the optical sender and receiver are not capable of burst signals, a constant change of amplitude of the signals in the send and receive directions must be assured. That can for example be achieved with an additional clocked code generator in the wavelength multiplex method. A possible chip can be the ADF4110 from Analog Devices that operates as a Phase lock loop (PLL) for 480 MHz. The code table is primarily defined in such a way that in a high speed USB transmission there is always activity on the optical channels, and also in cases where gaps in the data stream still occur, the synchronization to the PLL on the other side of the channels is maintained. A related exemplary embodiment for the interface units 50 and 80 is shown in FIGS. 9 and 10.

In the exemplary embodiment according to FIG. 9 there are two wavelengths per send and per receive direction. The setup of the sending side recovery unit 400 which takes the signals from the analyzing unit 210 and which at output drives two optical sending units 410 and 420 is given as an example in FIG. 10.

The purpose of the recovery unit 400 is to generate two electrical driver signals S41 and S42 based on the useful signal NS and the control signals SS. As an example the logic states in the signal S41 are encoded by code patterns.

The signal 42 is generated by a multiplexer (MUX) and the intermediate value C3.

| S41 | HS_Differential_Receiver_Output | C3 |
|---|---|---|
| 0 | 0 | 0 |
| 1 | 1 | 0 |
| Code pattern | 0 | 1 |
| 0101 | | |
| Code pattern | 1 | 1 |
| 0101 | | |

The signal S41 is created with the help of the intermediate signals C1, C2 and C3 according to the following equations and the following table:

C1=NOT(Squelch) OR NOT(HS_Disconnect)

C2=NOT(Squelch) AND HS_Disconnect

C3=NOT (SE_Data+_Receiver_Output) AND NOT(SE_Data−_Receiver_Output)

| | Code-pattern für | | | |
|---|---|---|---|---|
| S41 | S42 | C1 | C2 | C3 |
| 0 | 0000 | 0 | 0 | 0 |
| 0101 | 0101 | 0 | 1 | 1 |
| 0 | 1111 | 1 | 1 | 0 |
| 1 | 1111 | 1 | 1 | 0 |
| 0 | 0011 | 1 | 0 | 0 |
| 1 | 0011 | 1 | 0 | 0 |

The following table shows the coding scheme in a different structure in relation to the USB signal states:

| Coding table for | | | | | |
|---|---|---|---|---|---|
| sending from device | | | | | |
| 10 to device 20 | | | | | |
| (signal states according | | | | | |
| to USB2.0- | | Code-pattern | | | |
| Standard) | S41 | for S42 | C1 | C2 | C3 |
| Disconnect | 0 | 0000 | 0 | 0 | 0 |
| Idle | 0101 | 0101 | 0 | 1 | 1 |
| K | 0 | 1111 | 1 | 1 | 0 |
| J | 1 | 1111 | 1 | 1 | 0 |
| 0 | 0 | 0011 | 1 | 0 | 0 |
| 1 | 1 | 0011 | 1 | 0 | 0 |

The aforementioned exemplary embodiments are based on the assumption that the different wavelength channels have different wavelengths. Alternatively it is also possible that optical spectrums are overlapping partly or completely as shown in FIG. 11a through another exemplary embodiment that uses an LED with spectrum 500 and a laser with the spectrum 510. The spectrum 510 lies within the spectrum 500.

In case of overlapping spectrums, the receiver side filter functions look like the example given in FIG. 11b. The curve 520 shows as an example a filter characteristic (transmission characteristic) that lets through the spectrum 510 of the laser, and the curve 530 shows as an example the filter characteristic to get the signals of the LED or the spectrum 500 of the LED.

The different wavelength channels can be transferred over a single waveguide or over multiple waveguides. I.e. two optical fibers can be used where one fiber is for receiving and the other for sending.

If only one optical fiber is used for both sending and receiving than the separation of the two directions can be achieved with i.e. an optical circulator or dedicated wavelengths are used for sending and receiving, i.e. λ1, λ2, λ3 for sending and λ4, λ5, λ6 for receiving.

A related exemplary embodiment is shown in FIGS. 13a and 13b. In 13a curve 601 is the laser sending spectrum and the curves 602 the sending spectrums of two LEDs. The filter characteristic 611 to filter out the laser spectrum and the filter characteristics 612 and 613 to filter out the signals of the LEDs are shown in FIG. 13b.

1. Interface unit (50, 80) with
an electrical interface (40, 110) for connection to a USB cable (30, 100),
an optical interface (60, 70) for connection to at least one optical waveguide (90) for sending and receiving of optical signals (S1′, S2′, S3′, S4′) and
a conversion unit (21), that is capable of converting the signals D+ and D− at the electrical interface to optical signals for output at the optical interface, and that is capable of converting the optical signals from the optical interface to electrical signals and output these signals as D+ and D− at the electrical interface
wherein the conversion unit has an analyzing unit (210) that separates the useful data (NS) and the control data (SS) contained in the signals D+ and D−,
wherein the analyzing units feeds the data to a recovery unit (220, 400) that generates at least two electrical driver signals (S1, S2, S11, S12, S13) based on the useful signal (NS) and single or all of the control signals (SS) for driving subsequent sending units (240, 250, 410, 420, 430), and
wherein subsequent sending units with at least two electrical driving signals generates at least two optical signals (S1′, S2′, S11′, S12′, S13′) with at least two different wavelengths channels (λ1, λ2, λ3) and outputs these at the optical interface.

2. Interface unit according to claim 1, wherein the conversion unit (200) transfers the useful signal (NS) on a separate and dedicated wavelength channel (S1′).

3. Interface unit according to claim 1, wherein the recovery unit (400) logically combines at least two of the control signals to an electrical driver signal (S12, S13, S22) and
wherein a subsequent sending unit (420, 430) generates an optical signal (S12′, S13′, S22′) with a dedicated wavelength channel (λ2, λ3) based on the driver signal and outputs it at the optical interface.

4. Interface unit according to claim 1,
wherein the recovery unit (400) logically combines at least one of the control signals with the useful signal (NS) to an electrical driving signal (S21), and
wherein a subsequent sending unit generates an optical signal (S21′) with a dedicated wavelength channel (λ1) based on the driver signal and outputs it at the optical interface.

5. Interface unit according to claim 1, wherein the wavelength channels (λ1, λ2, λ3) have different wavelength ranges.

6. Interface unit according to claim 1, wherein the wavelength ranges of the wavelength channels (λ1, λ2, λ3) overlap but still have different spectral widths.

7. Interface unit 50, 80) with
an electrical interface (40, 110) for connection to a USB cable (30,100),
an optical interface (60, 70) for connection to at least one optical waveguide (90) for sending and receiving optical signals (S1′, S2′, S3′, S4′), and
a conversion unit (21) that is capable of outputting the D+ and D− signal from the electrical interface as optical signals at the optical interface and is capable of outputting the optical signals from the optical interface as electrical signals D+ and D− at the electrical interface
wherein
the conversion unit (200) contains a recovery unit (320, 440) that is capable of simultaneously receiving at least two optical wavelength channels at the optical interface and converting these at least two optical wavelength channels to a useful signal (NS) and control signals (SS), and
the recovery unit (320, 440) is connected to an analyzing unit (210) that generates the signal D+ and D− out of the control signals (SS) and the useful signal (NS) for output at the electrical interface

8. Method for transmission of a USB compatible signal where the signals D+ and D− after electro-optical conversion are transferred as optical signals over at least one optical waveguide (90) wherein a useful signal (NS) and control signals (SS) are derived from the electrical D+ and D− signals and are transferred on at least two different wavelength channels on at least one optical waveguide (90)

9. Method according to claim 7, wherein the useful signal (NS) is transferred on a separate and dedicated wavelength channel (S1′)

10. Method according to claim 7, wherein at least two control signals are logically combined and that the combined signal (S12, S13, S22) is then transferred on a separate and dedicated wavelength channel (S12′, S13′, S22).

11. Method according to claim 7 wherein at least one of the control signals is logically combined with the useful signal (NS) and that the combined signal (S21) then is transferred on a separate and dedicated wavelength channel (S21′).
